(19) United States
(12) Patent Application Publication
(10) Pub. No.: US 2023/0309581 A1
(43) Pub. Date: Oct. 5, 2023

(54) SILAGE STABILIZERS

(71) Applicant: UNIVERSTIY OF BELGRADE, Belgrade (RS)

(72) Inventor: Aleksandra Ivetic, Belgrade (RS)

(21) Appl. No.: 18/023,721

(22) PCT Filed: Sep. 29, 2020
(86) PCT No.: PCT/RS2020/000013

§ 371 Date: Feb. 27, 2023

(30) Foreign Application Priority Data
Aug. 31, 2020 (RS) P-2020/1040

(51) Int. Cl. A23K 30/15

(52) U.S. Cl. CPC A23K 30/15

(57) ABSTRACT

The subject invention relates to new silage stabilizers comprising as active ingredients citric acid, sodium bicarbonate and catalyst cobalt (II) chloride and/or iron powder. The subject invention relates to use of the silage stabilizers mixture for preservation of the silage, namely use in ensiling plants and preserving silage in round bales and horizontal silos and functional packaging of active ingredients and method of use of the Silage stabilizers for ensiling in horizontal silos and round bale.

### TECHNICAL FILED

The subject invention relates to new silage stabilizers as mixture comprising as active ingredients citric acid (2-Hydroxypropane-1,2,3-tricarboxylic acid,), sodium bicarbonate (NaHCO₃) and catalyst cobalt (II) chloride (CoCl₂) and/or iron (Fe) powder. The subject invention relates to use of the silage stabilizers mixture for preservation of the silage, namely use in ensiling plants and preserving silage in round bales and horizontal silos and functional packaging of active ingredients and method for ensiling in horizontal silos and round bales by using the Silage stabilizers. In order to preserve chemical activity of the active ingredients and prevent chemical reaction prior to application of the silage stabilizers mixture, active ingredients and catalysts are packed in nontrivial functional packaging.

### PRIOR ART DOCUMENT

Prior art document WO2015/041556, from the same inventor, solves problem of conserving/ensiling feed, by using of carbon dioxide, in two different aggregate states, i.e. the use of carbon dioxide in solid state (dry ice), or gaseous state in the process of conserving/ensiling feeds.

This time, the inventor went further and provided the silage stabilizers which, by the ratio of their constituent components, eliminates the need to apply carbon dioxide in the ensiling process in order to create optimal conditions for obtaining quality silage.

As a closest prior art, WO9714317 discloses a process for preparing animal feed or fermented feed by adding a first compound, in particular solid bicarbonate, carbonate and decarboxylate, preferably pyruvate or solid anhydrous sodium bicarbonate and other compounds more precisely anhydrous organic or inorganic acid namely anhydrous citric acid in an amount of 50-60 kg/100 t of silage and preferably 10-30 kg/100 t of silage, with a moisture content in the silage of at least 50%. In addition, silage auxiliaries are added, e.g. alkali or alkaline earth metal salts of formic acid, propionic and sorbic acids, formaldehyde-producing substances, sugar-containing compounds, e.g. molasses, and in particular the ensiling material or bacteria or lactic acid enzymes on the carrier.

The present invention provides a stabilizer comprising sodium bicarbonate, citric acid and cobalt (II) chloride and/or iron powder as catalysts. The person with average skills in the art knows that the important factors for silage preparation are not only the amount of emitted CO₂, that represents a basis for document WO9714317, but also the optimal pH values and other important factors for silage preparation, since it is a very complex change in nutritional preservation of the plants throughout the year in the open in large quantities. Namely, in the present invention, the ratio of citric acid and sodium bicarbonate is particularly indicated as an important factor in order to quickly achieve optimal pH values, which is not explicitly stated in this prior art document. Also, the present invention does not consider the addition of the additives listed in WO9714317. In the present invention, in order to achieve optimal ensiling conditions, a stabilizer with components (citric acid, sodium bicarbonate and catalyst(s)) is added in the amounts of 10-90 kg/100 t of silage, and preferably from 20 to 70 kg/100 t silage. This results in obtaining significantly better-quality silage compared to the results from the mentioned document. The present invention offers a better and, more importantly, a more complete solution for achieving optimal ensiling conditions, namely successful preservation of the silage and, above all, achieving an optimal pH value in the silo mass, which is crucial, in several respects.

The prior art document CA1300056, describes compositions for modifying the atmosphere in a closed container with a predetermined volume, to create an environment suitable for the growth or maintenance of capnophilic, microaerophilic and anaerobic microorganisms. The composition of the among other includes sodium bicarbonate, citric acid, metal powder (iron, aluminum, copper, nickel and zinc) reactive to oxygen for oxygen reducing and a catalyst (platinum, palladium) on an inert medium which is added to the material reactive to oxygen. The described packaging is divided into two chambers where in one there is a bag with a mixture of carbonate, powder catalyst and oxygen reactive material. The bag is made of a porous material, in order to allow water to enter the bag and thus enable the reaction of gases in the bag with the contents of the bag. The reaction of these components takes place with the addition of water placed in a special container which is added to the same section with the mixture. In the second chamber are placed Petri dishes with the growth medium(s). It is obvious that packaging takes on the role of a container for microbiological tests in order to provide anaerobic conditions for the development of certain colonies on selected microbiological media. Containers with substrates inside are placed in laboratory incubators at a certain temperature for a certain time, depending on which colonies of MO want to be isolated on such selective substrates with the use of these bags that release CO₂ to achieve anaerobic conditions. Unlike CA1300056, the present invention aims to use a Stabilizer of the specified composition during ensiling to provide optimal and complex conditions for obtaining silage with preserved plant nutrient values throughout the year, in open space in quantities of the order of several hundred kilograms to thousand tons. As will be described below, the silage stabilizers according to the present invention, intended for ensiling, describes, inter alia, the functional packaging of the components of the two-chamber bag-shaped silage stabilizers for application to horizontal silos. The silage stabilizers contain citric acid, sodium bicarbonate and catalysts cobalt (II) chloride and/or iron powder.

Compared to stated prior art, in the present invention, in one chamber is placed citric acid or sodium bicarbonate and the catalyst is in solid form in the indicated ratio, and in the other chamber is placed sodium bicarbonate or citric acid. For the reaction between the components of the present invention, the need to add water has been eliminated. Thus, the present invention does not include special packages (containers/vials) with water.

For round bales, the present invention provides a solution for packaging components in a single bag, made of biodegradable material, without added special packaging (container/vial) with water, also the present invention eliminates the need to pre-wet the bag with components to initiate the reaction as required by the solution described. in document CA1300056.

Prior art document GB1440283 discloses the animal feed preserved by the addition of hexamethylene tetramine and one or more organic acids that are selected from formic acid, acetic acid, citric acid, tartaric acid, etc, with optional addition of preservative. This preserved feed may be used for all kinds of feed of vegetable or animal origin e.g. cereals (maize, wheat); residues from oil-bearing seeds such as cotton, soya beans and rape: potatoes, beets, fish meal, meat meal and silage.

From the above, it is obvious that the composition of the silage stabilizers differs significantly from the components that are part of the composition for ensiling from the stated state of the art.

Another prior art document CN108477390 is related to the invention that discloses a silage conditioning agent and a usage method thereof. The silage conditioning agent is prepared by mixing citric acid with fumaric acid. The usage method of the subject silage conditioning agent comprises dissolving the silage conditioning agent by using purified water, and uniformly spraying the dissolved silage conditioning agent onto the silage raw-material.

Moreover, prior art document CN104522304 is referring to a ensiling method and a method for preparing silage by using bamboo shoot shells and a silage pit. The method for preparing the silage by using the bamboo shoot shells comprises the collecting the fresh bamboo shoot shells and airing, mixing and uniformly stirring the bamboo shoot shells with table salt, urea, citric acid and molasses, placing the mixture into the silage pit to be sealed until an ensiling process is finished, and thus preparing the bamboo shoot shell mixture in the silage pit into the silage.

### BACKGROUND OF THE INVENTION

Silage is a technological process of fermentation and canning high-moisture plants intended primarily for feeding domestic animals. Nutrient preservation is done with the help of acids that are obtained by the work of bacteria during spontaneous or directed lactic acid fermentation. As a result of the whole process, silage was obtained, which is used in the diet of animals on farms throughout the year. By using carbohydrates, lactic acid bacteria—LAB produce lactic acid—LA and acetic acid
AA, preserving nutrients in the silage. Also, silage can be made for preserving by-products of the horticulture, vegetable and food industry.

The main goal of ensiling plants is to preserve their nutritional value during storage as close as possible to the nutritional value they had before canning as a fresh plants. In terms of composition, silage is closer to greenfeed than hay, both in terms of digestibility and in terms of dry matter, vitamins and proteins, with less loss of nutrients during the applied technology. Plants that give high yields, such as corn, can be used for silage, but due to the roughness of the tree and other biological properties, they are not suitable for feeding domestic animals in a fresh state. Also, corn is the dominant plant that is used in the form of silage in our country as well as in many parts of the world. Silage of legumes can provide significant amounts of protein which is often deficient if provided only from concentrated nutrients. Silage enables better exploitation of the land, because two different crops can be produced on the same surface in one vegetation period.

The technology of silage preparation consists of several routine techniques: harvesting and cutting plants into smaller pieces, their transport from the field to the farm, filling and pressing the plant mass in the silo, and the final technique of covering the silo with foil. Each step brings with it a number of possible consequences for the quality of the obtained silage if it is not implemented correctly. The main points of risk are the selection of the correct stage of maturity of the plant for ensiling, the rapid extrusion of air within the plant mass in the silo and the correct coverage.

Changes in the silo mass occur practically as soon as the mass of plants is transferred from the field to the prepared silo object. What will be the course and intensity of the change depends on a number of factors, but mostly on those that condition the successful development of lactic acid fermentation, such as: moisture in the nutrient, anaerobic environment, carbohydrate content and temperature. These factors enable the conditions in which the desired microorganisms will dominate during the fermentation of the plant mass and obtaining quality silage with high nutritional value.

The main goal in ensiling crops through natural fermentation is to provide anaerobic conditions in the environment in order to prevent the development of undesirable microorganisms (MO) and enable the growth and development of the necessary LAB.

Silage always contains a large number of MOs that originate from the epiphytic microflora of plants. These are MOs that are normally found on the surface of plant parts. In addition to the plants used for ensiling, MOs reach the silage from the air, from the silage chopping machines, tools, floors and walls of the silage facilities. By chopping plant parts and transporting them to the silo, the conditions for the development of epiphytic microflora change significantly because the cell membrane is destroyed at the intersections of leaves and green stems, which leads to the release of plant juice. Increasing the number of microorganisms and decreasing the pH value of silage is all the faster if more plant juice is extracted and as much air as possible is expelled.

The phases of chemical changes during plant ensiling are: 1) respiration of plant material, 2) formation of AA, 3) formation of LA, 4) calming of the fermentation process, 5) if the ensiling process is not carried out correctly—formation of butyric acid-BA and 6) aerobic degradation.

The first phase begins in the field when the plant is harvested or mowed. Epiphytic MOs are normally present on crops and affect silage fermentation as well as the efficiency of added microbiological inoculants. Aerobic bacteria disappear during the first two days after ensiling if an anaerobic environment is reached, while gram-negative coliform bacteria can multiply until the end of the first week after ensiling depending on the increase in pH. In commercial silages, during the initial stages of fermentation, when air is still present between parts of the plants, the temperature can rise to 40° C. and above due to continued plant respiration and aerobic microbial activity.

Consumption of air trapped in the silo mass during the initial aerobic phase is a trigger that activates the formation of the anaerobic fermentation phase. Primarily by the work of Enterobacteria that are tolerant to heat increase (during the aerobic phase), several different products are formed. The first product of microbiological activity in silage is AA. These phase of fermentations mainly take place in the range of pH 6-4, 2. When the pH value drops below pH 4-4.5, the action of Enterobacteria bacteria is slowed down and their reproduction is stopped.

In the ensiling process, the most important product of microbiological activity is LA, which is silage preservative. The phase of formation LA is the most important and most necessary for obtaining top quality silage. The third and fourth phases together form the phase of creating LA. The third phase lasts a short time of about 24 hours and is a transit to the 4 phase. The drop in pH value enables an increase in the population of LAM, which additionally, through their work and production of LA, establish the necessary acidity of the environment.

This acid is the strongest and most effective Volatile Fatty Acid—VFAs for rapid pH reduction. In silages of the best quality dominates LA. In well-preserved silage, at least 65-70% of the total acid will be lactic acid or 4-7% lactic acid (% DM), Ward and Ordanza, 2008. From the Hill-Laboratories, New Zealand, it is recommended that lactic acid should comprise 65% of the total VFAs content and that the LA: AA ratio should not be less than 3:1. High levels of AA (>3-4%) or BA (>0.5%) in any type of silage are indicators of less than desirable silage fermentation.

Stages 2, 3 and 4 are the longest stages of silage fermentation and last until the pH value in ensiled plants reaches a value that inhibits the potential development of all MOs. In natural fermentation with epiphytic MO and without additives during ensiling, the duration of these phases is from 10 days to 3 weeks. The time span depends on the buffer capacity of the plant, the moisture and the maturity of the crop being ensiled.

The calming phase occurs when the production of LA reached its maximum in ensiled plant mass and thus caused a decrease in pH below 4, 2. Further development and biochemical activity of LAB was reduced to a minimum while the work of anaerobic bacteria was almost completely stopped. Aerobic microorganisms cannot develop due to the lack of oxygen, which is partly consumed by the respiration of plant tissue and partly by the development of aerobic and facultative anaerobic microorganisms, even in the first and second phase of ensiling.

The phase of aerobic degradation (deterioration) of silage begins immediately after exposure of silage to air. During animal feeding, this phase is inevitable and takes place in all silages, regardless of quality. It consists of two stages. The first represents the beginning of deterioration due to the degradation of protective organic acids. By increasing the pH value, the second stage of spoilage begins, in which the temperature and the speed of development of microorganisms increase.

Aerobic degradation of nutritive value occurs in all silages that are open and exposed to air. Air (oxygen) is the main cause of deterioration in the quality of silage, because it enables unwanted chemical and microbiological activities, which lead to aerobic degradation of silage. The degree of degradation and the length of aerobic stability of silage after the opening of the silo depend on its quality. During silage feeding, the rate of removal and the thickness of the frontal cut-off affect the length of time the silage is exposed to air.

There is a risk of subsequent fermentation. Butyric fermentation is characterized by microbiological decomposition processes with the release of putrefaction products, and this phase is detrimental to the quality of silage and marks the beginning of silage moldering. A typical “clostridial silage” has a high BA content (more than 5 g/kg SM), a high pH (over 5) and a high ammonia and amine content, The ensiling method that quickly and sufficiently reduces the pH of silage has a role in preventing the development of clostridia because, similar to Enterobacteria, their work is inhibited at low pH values.

### DESCRIPTION OF THE DRAWING

FIG. 1: Double chamber bag for packaging silage stabilizers for horizontal silos.

### DETAILED DESCRIPTION

The subject invention relates to new silage stabilizers which are mixture comprising as active ingredients citric acid, sodium bicarbonate and catalyst cobalt (II) chloride and/or iron (Fe) powder. The subject invention relates to use of the silage stabilizers mixture for preservation of the silage, namely use in ensiling plants and preserving silage in round bales and horizontal silos and functional packaging of active ingredients. In order to preserve chemical activity of the active ingredients and prevent chemical reaction prior to mixing and applying the silage stabilizers, active ingredients and catalysts are packed in functional packaging.

According to the stated facts, the main problems of good ensiling are the achievement of a lower pH value and the rapid removal of air from the silo mass in a safe way. The present invention aims to solve both problems. The present mixture is safe for human and animal use, as well as for the environment. The silage stabilizers contain a mixture of EU approved feed and food preservatives.

The subject invention solves those problems by providing safe and efficient way to preserve silage from deleterious oxidation by air and creates safe environment for development of LAB, it is based on bioremediation, because it uses LAB that are already present on plants, without adding inoculants. The silage stabilizers act in several ways: they reduce the breakdown of proteins in silage, protects the DM content in the silo mass, improves aerobic stability due to lower pH value and higher content of LA and AA compared to control silage.

The silage obtained by treatment with the silage stabilizers of the present invention is tested on several farms and results are provided in the experimental section of the description.

Therefore, the subject invention provides new silage stabilizers which are mixture comprising as active ingredients citric acid i.e. hydroxypropane-1,2,3-tricarboxylic acid sodium bicarbonate i.e. NaHCO₃ and catalyst cobalt (II) chloride i.e. CoCl₂ and/or iron i.e. Fe powder. The subject stabilizer is intended for use in solid form for ensiling in horizontal silos and round bales.

Plants for ensiling with the subject silage stabilizers mixture are plants selected from Z.mays, family, namely Fabaceae (Leguminosae), plants from Poaceae family (corn,rye, wheat, barley, oats, sorghum, various grasses), grass-leguminous mixtures and other plant mixtures.

This combination of active ingredients with catalysts provides faster reaching the anaerobic phase of the fermentation, lower pH value, and absorbance of sufficient moisture and dry matter preservation. By this LAB that are present on epiphytic microflora can fermented plants mass, biomass to silage for a shorter period of time, compared to the traditional technics. Quality of the silage is higher because of the nutritional value achieved with this mixture, as well as by-products of horticulture, vegetables and the food industry.

The person skilled in the art knows that the substantial factor for silage preparation is not only the amount of CO₂ released, but also the optimal pH values and other important factors for silage preparation, because of very complex change in process of preserving the nutritional value of plants throughout the year and in large quantities. Specifically by the combination and the indicated ratio of the components that are contained in the silage stabilizers according to the present invention, the best conditions for ensiling and obtaining a silage of exceptional quality have been achieved, as described in the experimental part.

The silage stabilizers are applied evenly in the horizontal silo by means of a cyclone, creating a layer on the biomass that is ensiled. Those layers can be repeated several times on silo mass before the covering of the silos. This provides protection from bad weather conditions when ensiling is interrupted due to the e.g. rain. Fast injection of air from silo mass (oxygen) provides anaerobic conditions for growth and reproduction of LAB and inhibits growth unwanted MOs. Aerobic stability of such silages is prolonged about 30% compared to the traditional one. Losses from silage spoilage or loss of nutritional value had been decreased for more than 30%.

Additionally, preparing silage from certain plants (alfalfa, grass, rye, etc.) require necessary wilting on the field. Bad weather conditions very often present the problem for first, second and last cut for example lucerne during ensiling season. By adding the subject silage stabilizers mixture that absorb moisture providing necessary dry matter content, the time for wilting can be significantly decreased.

The silage stabilizers of the present invention comprises citric acid and sodium bicarbonate in the ration within the range of 90: 10 up to 50:50, with optimal pH of 2,7 to 5,55.

The total amount of catalyst cobalt (11)-chloride and/or iron in powder form added is 10 −30 mg per 10 kg of the silage stabilizers mixture.

Namely, the silage stabilizers of the present invention are intended for use for ensiling in horizontal silo and in round bales.

In a horizontal silo, the amount of silage stabilizers mixture used ranges from 10 kg-90 kg per 100 tons.

Preferably, for use in a horizontal silo, the amount is 20-70 kg per 100 tons.

The ways of stabilizer is applied in a horizontal silo are:
A) In two spreading: in the upper third and the second, 10 cm before the final layer;
B) In one spreading: 10 cm before the final layer;
C) by a cyclone, fertilizer spreader.

For the round bales application:
A) Quantity of silage stabilizers mixture of 0,4-2.5 kg per bale;
B) Two to eight (2 to 8) bags with the stabilizer per one round bale;
C) The bags are placed before rolling the foil on the round bale.

The combination of active ingredients, namely citric acid and sodium bicarbonate react immediately in silo mass. Both reagents are supplied from the conventional chemical manufacturers.

Considering that both compounds react immediately when mixed, the packaging were made:
1. For horizontal silo: in bags with two chambers (compartments), with catalysts both/single being added either in both compartments, or separately, preventing compounds from undesirable absorption of moisture any interactions.
2. For round bales: vacuum packaging comprising two bags, wherein inner one with mixture with catalysts is made of porous biodegradable material, while the external bag is sun, air and moisture impermeable. The function of external bag is to prevent the content, namely mixture and catalysts, from deleterious impact of environmental conditions. Round bales can vary in sizes and weights, therefore the optimal dimensions of bags (width×length) can also vary from 20 cm×80 cm to 50 cm×100 cm.

Method of Use of the Silage Stabilizers on Horizontal Silo

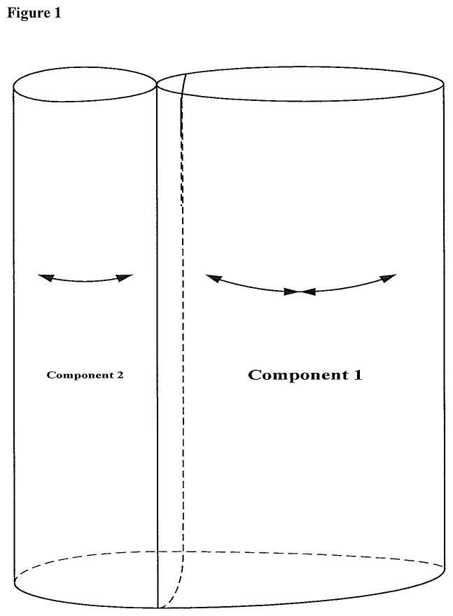

For the horizontal silos, the silage stabilizers are made in a package in a two-chamber bag, as presented on FIG. 1, which prevents mixing of the components before ensiling, preserving the original activities and structures. One chamber contains citric acid and catalysts, while the other chamber contains sodium bicarbonate. Also, it is possible to put the catalysts in a chamber with sodium bicarbonate, while in the other chamber there is only citric acid.

The packaging with silage stabilizers of the subject invention is cut open and added to the fertilizer cyclone, that is used to sprinkle the silage stabilizers to the corresponding mass, before covering the silo. In this way, the mixture is applied evenly and human resources are avoided. The cyclone fertilizer spreader carries the tractor or other farm vehicle during process of biomass pressing.

Distribution with a cyclone on the surface of the ensiled plant mass, provides an uniform distribution of the active ingredients in a thin layer. This uniform distribution also applies to the area around the edges and corners of the silos, which has so far been a problem when compacting plant mass due to difficult access of mechanization that compacts plant mass to this area in horizontal silos. This balances the overall quality of silage, prevents losses and the resulting silage is class I quality.

Method of Use of the Silage Stabilizers on Round Bales

Two types of bags were made: outer and inner. The outer bag is non-porous and protects from the penetration of sunlight, air and moisture into the mixture. The inner bag is porous and made of biodegradable material. Components of the silage stabilizers are located in the inner bag, which is placed directly on the biomass of round bale when wrapping the foil. After placing the inner, porous bag (closed by welding), in the outer opaque one, the outer bag is first vacuumed and then welded with a bag welder. Four inner bags were placed on each side of one round bale. After placing the bags, bales are wrapped with the foil.

Experiments and Results

The experiments were conducted with ensiling the corn, alfalfa and ray, separately in different farms. Corn was ensiled in horizontal silos, alfalfa was ensiled in round bales and horizontal silos, and ray was ensiled in round bales. Prior ensiling green mass of alfalfa and ray were wilted.

After ensiling was completed, samples of silages were collected for laboratory analyses. The DM content was determined by drying at 80° C. in an oven for 20 h. The crude ash content was determinate after combusting samples at 600° C. for 3 h. The content of CP was determined by micro-Kjeldahl method (method 988.05; AOAC, 1990), using K₂SO4/Se catalyst-Kjeltabs S 3,5, on the device Kjeltec Auto 1030 Analyzer—Tecator System. The crude fat content was determined by the diethyl ether extraction method, using a Soxlett apparatus (method 920.39; AOAC, 1990). The content of fibers insoluble in neutral detergent—NDF was determined using thermostable α-amylase (A3306 Sigma Chemical Co., St Louis, MO), and sodium sulfite (Official Method 2002: 04; AOAC 2002, EN ISO 16472: 2006, Van Soest et al., 1991). According to the methods: Official Method 973.18 AOAC 1990; EN ISO 13906: 2008; Goering and Van Soest, (1970) the content of fibers insoluble in acid detergent—ADF was determined. After determining ADF weights, residues were incubated for 3 h in 72% sulfuric acid, for lignin -ADL determination.

The energy value of nutrients is calculated according to Tylutki et.al. (2008). Prediction of ME content was done using the NRC 2001 computer model (5.0.40 version). Then, using the equations from the NRC 2001 model, the NEL content of experimental maize silage and alfalfa silages was calculated. The determination of structural carbohydrates, cellulose polysaccharides and hemicelluloses was done by calculation. Hemicelluloses—HC content was calculated according to the formula (Muck et al., 2007):

HC=NDF−ADF

The cellulose content of CEL was calculated according to the formula (Muck et al., 2007):

CEL=ADF−ADL

The content of non-fibrous carbohydrates NFC was calculated using the NRC-2001 computer model using the formula:

NFC,%=100−(CP,%+EE,%+Ash,%+NDF,%+NDFICP,%)

Farm 1

In the farm 1, corn was ensiled in 2 horizontal silos for a 150 days of silo opening.

| Nutrients | Control | Analyses |
|---|---|---|
| Moisture | 61.51 | 58.49 |
| Dry Matter-DM | 38.49 | 33.23 |
| in 100% DM, % | | |
| Crude protein-CP | 9.00 | 8.59 |
| Ether extract-EE | 2.32 | 2.10 |
| Ash | 4.29 | 3.85 |
| Neutral detergent fiber-NDF | 50.87 | 40.33 |
| Acid detergent fiber-ADF | 29.82 | 23.47 |
| Acid detergent lignin-ADL | 8.71 | 3.16 |
| Nonfiber carbohydrate-NFC | 34.80 | 46.40 |
| Cellulose-CEL | 21.11 | 20.31 |
| Hemicelullose-HC | 21.05 | 16.86 |
| Predicted energy concentration, | | |
| (NRC, 2001), MJ/kg SM | | |
| Digestible energy-DE | 10.46 | 12.34 |
| Metabolic energy-ME | 8.70 | 10.54 |
| Net energy-NE_{L} | 5.31 | 6.61 |

Total Organic Acid Content and Evaluation of Silage Quality by DLG:

1. Control Treatment

| | Acid | Portion, % | Content, % | Points | Evaluation |
|---|---|---|---|---|---|
| 1. | LA | 58.77 | 0.67 | 18 | III quality |
| 2. | AA | 15.79 | 0.18 | 10 | class |
| 3. | BA | 25.44 | 0.29 | 2 | |
| 4. | pH value | 5.25 | — | 4 | |

| | |
|---|---|
| Σ | 34 |

2. Analyses—Treatment with Silage Stabilizers

| | Acid | Portion, % | Content, % | Points | Evaluation |
|---|---|---|---|---|---|
| 1. | LA | 79.88 | 1.31 | 20 | I quality class |
| 2. | AA | 20.12 | 0.33 | 10 | |
| 3. | BA | — | — | 10 | |
| 4. | pH value | 4.19 | — | 10 | |

| | |
|---|---|
| Σ | 50 |

Farm 2

In the farm 2, corn was ensiled in 2 horizontal silos with 100 days of opening.

| Nutrients | Control | Analyses |
|---|---|---|
| Moisture | 61.72 | 60.12 |
| Dry Matter--DM | 38.28 | 39.88 |
| in 100% DM, % | | |
| Crude protein-CP | 8.49 | 7.97 |
| Ether extract-EE | 2.27 | 2.14 |
| Ash | 3.54 | 3.46 |
| Neutral detergent fiber-NDF | 44.71 | 45.21 |
| Acid detergent fiber-ADF | 27.93 | 26.74 |
| Acid detergent lignin-ADL | 7.84 | 5.47 |
| Nonfiber carbohydrate-NFC | 42.30 | 42.50 |
| Cellulose-CEL | 20.09 | 21.27 |
| Hemicelullose-HC | 16.78 | 18.47 |
| Predicted energy concentration, | | |
| (NRC, 2001), MJ/kg SM | | |
| Digestible energy-DE | 11.09 | 11.55 |
| Metabolic energy-ME | 9.33 | 9.79 |
| Net energy-NE_{L} | 5.77 | 6.07 |

Total Organic Acid Content and Evaluation of Silage Quality by DLG:

1. Control Treatment

| | Acid | Portion, % | Content, % | Points | Evaluation |
|---|---|---|---|---|---|
| 1. | LA | 19.73 | 0.29 | 2 | V quality |
| 2. | AA | 44.22 | 0.65 | 6 | class |
| 3. | BA | 36.05 | 0.53 | 1 | |
| 4. | pH value | 4.51 | — | 8 | |

| | |
|---|---|
| Σ | 17 |

2. Analyses—Treatment with Silage Stabilizers

| | Acid | Portion, % | Content, % | Points | Evaluation |
|---|---|---|---|---|---|
| 1. | LA | 81.38 | 2.18 | 20 | I quality class |
| 2. | AA | 17.13 | 0.46 | 10 | |
| 3. | BA | 1.49 | 0.04 | 9 | |
| 4. | pH value | 3.94 | — | 10 | |

| | |
|---|---|
| Σ | 49 |

Farm 3

In the farm 3, alfalafa (Medicago sativa) was ensiled in round bales, first-cut, with 300 days of silo opening.

| Nutrients | Control | Analyses |
|---|---|---|
| Moisture | 43.99 | 47.50 |
| Dry Matter-DM | 56.01 | 52.50 |
| in 100% DM, % | | |
| Crude protein-CP | 17.17 | 17.37 |
| Ether extract-EE | 2.71 | 2.65 |
| Ash | 9.10 | 10.28 |
| Neutral detergent fiber-NDF | 49.41 | 45.25 |
| Acid detergent fiber-ADF | 35.17 | 28.37 |
| Acid detergent lignin-ADL | 9.30 | 7.50 |
| Nonfiber carbohydrate-NFC | 24.70 | 27.60 |
| Cellulose-CEL | 25.87 | 2.87 |
| Hemicelullose-HC | 14.24 | 16.88 |
| NH₃-N, % Total N | 3.68 | 1.16 |
| Predicted energy concentration, | | |
| (NRC, 2001), MJ/kg SM | | |
| Digestible energy-DE | 10.42 | 10.88 |
| Metabolic energy-ME | 8.65 | 9.10 |
| Net energy-NE_{L} | 5.27 | 5.56 |

Total Organic Acid Content and Evaluation of Silage Quality by DLG:

1. Control treatment

| | Acid | Portion, % | Content, % | Points | Evaluation |
|---|---|---|---|---|---|
| 1. | LA | 29.07 | 0.25 | 6 | IV quality |
| 2. | AA | 23.26 | 0.20 | 10 | class |
| 3. | BA | 47.67 | 0.41 | 0 | |
| 4. | pH value | 5.39 | — | 4 | |

| | |
|---|---|
| Σ | 20 |

2. Analyses—treatment with Silage Stabilizers

| | Acid | Portion, % | Content, % | Points | Evaluation |
|---|---|---|---|---|---|
| 1. | LA | 93.07 | 1.33 | 20 | I quality class |
| 2. | AA | 6.93 | 0.1 | 10 | |
| 3. | BA | — | — | 10 | |
| 4. | pH value | 3.94 | | 10 | |

| | |
|---|---|
| Σ | 50 |

Farm 4

In the farm 4, mature alfaalfa (5th year of cultivation, 4th cutting) was ensiled in round bales, and 250 day of silo opening

| Nutrients | Control | Analyses |
|---|---|---|
| Moisture | 56.03 | 60.67 |
| Dry Matter-DM | 43.97 | 39.33 |
| in 100% DM, % | | |
| Crude protein-CP | 15.51 | 17.68 |
| Ether extract-EE | 2.40 | 4.32 |
| Ash | 11.00 | 11.43 |
| Neutral detergent fiber-NDF | 46.25 | 49.16 |
| Acid detergent fiber-ADF | 30.10 | 32.41 |
| Acid detergent lignin-ADL | 9.3 | 7.12 |
| Nonfiber carbohydrate-NFC | 27.90 | 20.50 |
| Cellulose-CEL | 20.79 | 25.29 |
| Hemicelullose-HC | 16.15 | 16.75 |
| NH₃-N, % Total N | 9.84 | 3.58 |
| Predicted energy concentration, | | |
| (NRC, 2001), MJ/kg SM | | |
| Digestible energy-DE | 10.41 | 10.88 |
| Metabolic energy-ME | 8.33 | 9.12 |
| Net energy-NE_{L} | 5.06 | 5.65 |

Total Organic Acid Content and Evaluation of Silage Quality by DLG:

1. Control Treatment

| | Acid | Portion, % | Content, % | Points | Evaluation |
|---|---|---|---|---|---|
| 1. | LA | 53.92 | 0.62 | 16 | III quality |
| 2. | AA | 10.43 | 0.12 | 10 | class |
| 3. | BA | 35.65 | 0.41 | 1 | |
| 4. | pH value | 5.15 | — | 5 | |

| | |
|---|---|
| Σ | 32 |

2. Analyses—Treatment with Silage Stabilizers

| | Acid | Portion, % | Content, % | Points | Evaluation |
|---|---|---|---|---|---|
| 1. | LA | 71.78 | 1.73 | 20 | II quality |
| 2. | AA | 26.97 | 0.65 | 10 | class |
| 3. | BA | 1.25 | 0.03 | 9 | |
| 4. | pH value | 5.23 | — | 4 | |

| | |
|---|---|
| Σ | 43 |

Farm 5

In the farm 5, alfalafa were ensiled in 2 separated horizontal silos with 300 days silos opening.

| Nutrients | Control | Analyses |
|---|---|---|
| Moisture | 44.86 | 44.51 |
| Dry Matter-DM | 55.14 | 55.49 |
| in 100% DM, % | | |
| Crude protein-CP | 21.73 | 20.50 |
| Ether extract-EE | 2.49 | 4.10 |
| Ash | 10.67 | 10.49 |
| Neutral detergent fiber-NDF | 46.13 | 43.89 |
| Acid detergent fiber-ADF | 27.42 | 27.26 |
| Acid detergent lignin-ADL | 10.05 | 7.68 |
| Nonfiber carbohydrate-NFC | 22.10 | 24.10 |
| Cellulose-CEL | 17.37 | 19.58 |
| Hemicelullose-HC | 18.71 | 16.63 |
| NH₃-N, % Total N | 2.38 | 1.45 |
| Predicted energy concentration, | | |
| (NRC, 2001), MJ/kg SM | | |
| Digestible energy-DE | 10.17 | 11.38 |
| Metabolic energy-ME | 8.62 | 9.62 |
| Net energy-NE_{L} | 5.27 | 5.92 |

Total Organic Acid Content and Evaluation of Silage Quality by DLG:

1. Control Treatment

| | Acid | Portion, % | Content, % | Points | Evaluation |
|---|---|---|---|---|---|
| 1. | LA | 75.68 | 0.84 | 20 | III quality |
| 2. | AA | 1.00 | 0.01 | 10 | class |
| 3. | BA | 23.32 | 0.26 | 3 | |
| 4. | pH value | 5.62 | — | 2 | |

| | |
|---|---|
| Σ | 35 |

2. Analyses—Treatment with Silage Stabilizers

| | Acid | Portion, % | Content, % | Points | Evaluation |
|---|---|---|---|---|---|
| 1. | LA T | 79.40 | 1.85 | 20 | I quality class |
| 2. | AA | 14.59 | 0.34 | 10 | |
| 3. | BA | 6.01 | 0.14 | 7 | |
| 4. | pH value | 4.59 | — | 8 | |

| | |
|---|---|
| Σ | 45 |

The ensiling trials assessed the chemical composition, energy and nutritional characteristics of the alfalfa and corn silage in field conditions at the commercial farm of cattle 1-5 are present in the experimental results. Feed is the factor that largely defines milk production. The nutrient composition and energy value of silage is limited largely by the quality, and content of net energy of lactation (NEI) is detrimental factor.

According to the conducted experiments on the farm, we can conclude that higher energy content NEI had all treated silage with Silage Stabilizers. In farm 1, ensiling corn in horizontal silos, control silage had NEI 5.31 MJ/kg SM compared with analyses, ensiled with silage stabilizers where content of NEI 6.61 MJ/kg SM. On the farm 4, mature alfaalfa (5th year of cultivation, 4th cutting) was ensiled in round bales, and with 250 day of silo opening, control silage had NEI 5.06 MJ/kg SM compared with analyses, ensiled with Silage stabilizers where content of NEI 5.65 MJ/kg SM.

This innovation results preservation of nutrients in silage (for animal feeding), that are not consumed in the initial respiratory aerobic phase for development and growth of undesirable microorganisms which cause spoilage and degradation of quality.

The new silage stabilizers product has shown that in field trials (farm 1-5) it has the ability to support the ensiling process. Those subject invention is based also on bioremediation, because we use LAB which already plants have, without inoculants addition. The silage stabilizers are operated in several ways: reducing protein degradation in silage, protecting DM content in silo mass, improving aerobic stability due to lower pH and higher lactic and acetic acid content compared to control silage.

According to the fermentation profile of the experimental silages, we concluded that the silage stabilizers had a positive effect on the fermentation flow and higher lactic acid content compared to the control silages of maize and alfalfa.

Ensiling corn or alfalfa without adding this innovative product, results from farms 1-5, resulted in III-V class of quality; compared with content of VFA's and quality of silages ensiled with Silage stabilizers which mostly I quality class, with average 80% share of lactic acid in the total content of VFAs.

The flavor and aroma of silage have always been recognized as being of the importance in determining the organoleptic quality of silage; odor and color indicate a lot about how well silage fermented. Plant bio-mass treated with this product had nice aroma, green color and pleasant odor during storage, which led to increased voluntary consumption in animals feed with such silages in farm 1-5. The addition of citric acid affects the increase of the flavor and aroma of silages due to the enrichment of the citrate content in the silo mass.

1. A silage stabilizer mixture consisting of:
citric acid: 2-Hydroxypropane-1,2,3-tricarboxylic acid,
sodium bicarbonate: NaHCO₃, and
catalysts: Cobalt (II) chloride: CoCI₂ and/or iron (Fe) powder,
wherein the effective amounts of citric acid and sodium bicarbonate are within a range of 90 : 10 up to 45: 65, and a catalyst being at least one of cobalt (II) chloride and iron in a powder form added are within the range of 10-30 mg per 10 kg of the silage stabilizer mixture.

2. A use of the silage stabilizer mixture of claim 1, for the preservation of a silage.

3. The use of the silage stabilizer mixture according to claim 2, wherein the silage comprises one or more of the group consisting of: plants from the corn Z.mays, family Fabaceae (Leguminosae), plants from the family Poaceae (rye, wheat, barley, oats, sorghum, various grasses), grass-legume mixtures and other mixtures of plants, as well as by-products of the horticulture, vegetable and food industry.

4. The use of the silage stabilizer mixture according to claim 3 in ensiling plants and further including the step of preserving the silage in at least one of round bales and horizontal silos.

5. The use of the silage stabilizer mixture according claim 4 in ensiling plants in the horizontal silos, wherein the total amount of the silage stabilizer mixture applied is within the range from 10 kg-90 kg per 100 tons, preferably, from 20 to 70 kg per 100 tons of the silage.

6. The use of the silage stabilizer mixture according to claim 4 in ensiling plants in the round bales, wherein the total amount of the silage stabilizer mixture applied is within the range of 0,4-2.5 kg per round bale.

7. The use of the silage stabilizer mixture according claim 6, in ensiling in the round bales, wherein the silage stabilizer mixture together with the catalyst is packed in an inner transparent bag made of a biodegradable material, which is then packed in an outer bag made of a non-porous material and then vacuumed.

8. The use of the silage stabilizer mixture according to claim 7, wherein the inner bag with the stabilizer mixture is placed directly on a biomass which is ensiled in a round bale when wrapping with a foil.

9. The use of the silage stabilizer mixture according to claim 8, wherein a total number of the inner bags placed on the biomass for ensiling in a round bale, is 2 to 8.

10. The use of the silage stabilizer mixture according to claim 5 in ensiling in the horizontal silos, wherein the silage stabilizer mixture is packed in a functional bag, with two vertical chambers, one of the two vertical chambers having a mixture of one of citric acid and sodium bicarbonate and a catalyst in a solid form in a specified ratio that packed in a special biodegradable bag, and in the other of the two vertical chamber is one of a sodium bicarbonate or a citric acid.

11. The use of the silage stabilizer mixture according to claim 10, wherein the silage stabilizer mixture is sprinkled from a spreader cyclone that is attached to a tractor or another farm vehicle, before covering the silo.

12. A method of use of the silage stabilizer mixture of claim 2 for ensiling in a horizontal silos, wherein the silage stabilizer mixture is contained in a bag, that is cut opened immediately prior to usage and poured into a cyclone spreaders that is attached to a tractor or another farm vehicle for pressing a biomass in the horizontal silos, and evenly sprinkling the silage stabilizer mixture on the ensiling mass from the cyclone spreader.

13. The method of use of the stabilizer mixture of claim 2 for ensiling in a round bales, wherein the silage stabilizer mixture together with at least one catalyst is packed in an inner transparent bag made of a biodegradable material, which is placed directly on a biomass which is ensiled in the round bale when wrapping with a foil.

14. The method of use according to claim 13, wherein a total number of inner transparent bags placed on the biomass for ensiling in the round bale, is 2 to 4.
